(19) United States
(12) Patent Application Publication
(10) Pub. No.: US 2012/0261391 A1
(43) Pub. Date: Oct. 18, 2012

(54) ATMOSPHERIC PRESSURE PLASMA METHOD FOR PRODUCING SURFACE-MODIFIED PARTICLES AND COATINGS

(75) Inventors: Jörg Ihde, Lilienthal (DE); Ralph Wilken, Rastede (DE); Jost Degenhardt, Bremen (DE); Alexander Knospe, Steinhagen (DE); Christian Buske, Steinhagen (DE)

(73) Assignees: Fraunhofer-Gesellschaft zur Förderung der angewandten Forschung e.V., München (DE); PLASMATREAT GMBH, Steinhagen (DE)

(21) Appl. No.: 13/500,435

(22) PCT Filed: Oct. 6, 2010
(86) PCT No.: PCT/EP10/64906

§ 371 Date: Jul. 5, 2012

(30) Foreign Application Priority Data
Oct. 6, 2009 (DE) 10 2009 048 397.7

(51) Int. Cl. B23K 10/00

(52) U.S. Cl. 219/121.52; 219/121.59

(57) ABSTRACT

Disclosed is a method for producing surface-modified particles in atmospheric pressure plasma, and a method for producing a coating with particles dispersed therein using an atmospheric pressure plasma. The plasma is produced by a discharge between electrodes in a process gas. In both methods one of the electrodes is a sputter electrode, which sputters the particles due to the discharge. Also disclosed are methods for producing composite material, with which surface-modified particles are built in a matrix, and to said composite materials. Also disclosed are plasma nozzles and devices containing said nozzles for producing surface-modified particles and coatings with the particles dispersed therein.

### FIELD OF THE INVENTION

According to a first aspect, the present invention relates to an atmospheric pressure plasma method for producing surface-modified particles. Using this method, surface-modified, for example coated particles, in particular coated microparticles and nanoparticles, can be formed in a simple manner. According to a further aspect, the invention relates to an atmospheric pressure plasma method for producing coatings having particles dispersed therein, in particular micro-particles and nanoparticles. The methods according to the invention are particularly simple for the reason that the particles, the surface of which is supposed to be modified or which are supposed to be incorporated into a coating, are produced in situ by sputtering at least one of the electrodes between which the discharge that generates the plasma burns. According to a further aspect, the invention relates to plasma nozzles, in particular atmospheric pressure plasma nozzles, and to devices that enable the implementation of the methods according to the invention and are specifically adapted therefor. The invention finally also relates to the use of a discharge in a plasma nozzle for sputtering particles from at least one electrode of the plasma nozzle.

### PRIOR ART

Microparticles and nanoparticles have been used for a number of years in various different fields of technology in order to modify the properties of products. For example, optical, electrical (for instance conductivity), thermal (for instance heat conductivity), electromagnetic and mechanical properties (such as stability and abrasion resistance) can be improved by incorporating such particles. For the best possible integration of the micro- and nanoparticles in the various matrices, it is advantageous to modify the surface of the particles. They can, for example, be provided with a coating. The compatibility between the matrix and the particles can often be improved in this manner.

Numerous methods were proposed in order to satisfy the demand for coated particles and layers in which particles are dispersed.

The low-pressure methods must first of all be mentioned.

DE-A-198 24 364 relates, for example, to a method for applying wear protection layers having optical properties to surfaces. The method comprises at least two different deposition steps. The one step is a plasma-enhanced CVD process for depositing a wear-protection matrix, and the other step is the deposition of a material by means of a PVD technique in order to incorporate optically functional materials into the matrix. The PVD technique used may, for example, be a sputtering method.

WO 2005/061754 relates to a method for producing a functional layer, wherein a deposition material is deposited on a substrate under the influence of a plasma, and wherein, at the same time, at least one second material is applied to the substrate with the aid of a second deposition process. PVD, such as sputtering, is inter alia cited as the second deposition process.

WO 2005/048708 relates to an antimicrobial and non-cytotoxic coating material comprising a biocide layer and a transport control layer covering the biocide layer. In embodiment example 6 of this document, the biocide layer is applied in a low-pressure DC magnetron sputtering process and the transport control layer is applied in a second process step by means of a plasma polymerisation process.

All low-pressure methods have high requirements in terms of apparatus since vacuum chambers are required, they normally only allow low deposition rates (in the range of a few nm/s) and require masks for coating locally. Furthermore, owing to the limited capacity of vacuum chambers, there are limits in respect of the size of the substrates and/or components that can be coated.

In order to avoid these disadvantages of the low-pressure methods, atmospheric pressure plasma methods were proposed.

Used in DE-A-199 58 473, for example, is a plasma jet source, as regards which it is stated that it can be operated in a fine vacuum up to an almost atmospheric pressure range. Specifically described is the simultaneous deposition of a matrix layer and of particles embedded therein as a functional coating. For this purpose, a micro-scale or nano-scale metal powder, such as TiN powder, is introduced together with a carrier gas into the plasma via the gas feed.

DE-A-198 07 086 relates to a method for coating substrate surfaces in a plasma-activated process at atmospheric pressure. A gas phase, which may contain a powdered solid, is thereby introduced into the plasma jet.

A precursor material is also supplied to the plasma jet in WO 01/32949 in order to coat surfaces in this manner. The precursor material may contain solid, for example powdered, components. Particles can thus be embedded in the deposited layers.

Atmospheric pressure methods were also used to modify the surface of particles. Described, for example, in DE-A-10 2005 042 109 and the corresponding WO 2007/028798 is a method for coating particles of a metal powder with an electrically insulating layer. An atmospheric pressure plasma source may be used. In order to coat the particles, the plasma is mixed with monomers and metal powder.

Common to all of the above-described atmospheric pressure plasma methods for producing layers having particles dispersed therein or for coating particles is the fact that the particles, for example in the form of powders, are supplied to the plasma jet from outside. This approach is accompanied by considerable problems if microparticles and especially nanoparticles are supposed to be incorporated in layers or coated. The reason for this is that microparticles and in particular nanoparticles have a strong tendency to agglomerate when they are in powder form.

DE-B-102 23 865 relates to a method for plasma coating work-pieces, in which, with the aid of a plasma nozzle, a jet of atmospheric plasma, with which the workpiece surface to be coated is covered, is generated by means of high-frequency electric discharge. The method is characterised in that at least one component of the coating material is contained as a solid in an electrode of the plasma nozzle and is sputtered from the electrode by means of the high-frequency discharge. As is apparent from DE-B-102 23 865, the sputtered material is predominantly in the form of highly reactive ions or radicals. According to the teaching of this patent, these species form homogeneous coatings, for example of metals or metal compounds. DE-B-102 23 865 does not teach the production of particles, let alone of particles that are subsequently surface modified.

In light of the prior art discussed above, the inventors were therefore faced with the object of proposing methods which avoid the aforementioned problems in connection with the agglomeration of particles and which enable the production of coatings having finely dispersed microparticles and in particular nanoparticles therein as well as the production of modified, in particular coated, microparticles and nano-particles, with this namely occurring at atmospheric pressure and having the advantages associated therewith as compared to low-pressure methods, such as, in particular, the more cost-effective performance of the method owing to the expendability of vacuum apparatus, the possibility of local coating without the use of masks and the higher deposition rates in the range of pm/s.

### SUMMARY OF THE INVENTION

This object is solved according to the invention by the atmospheric pressure plasma method for producing surface-modified particles as according to independent claim 1, as well as by the method for producing coatings having particles dispersed therein as according to independent claim 5. With the method according to claim 1, particles, in particular particles having a particle diameter in the range of nanometres to several tens of micrometres, can be surface modified, for example coated. With the method according to independent claim 5, coatings can be easily produced, in which particles, in particular particles within the aforementioned size range, are finely dispersed.

The invention is based on the surprising finding that in atmospheric pressure plasma methods, for example ones using a plasma nozzle, the electrodes between which the plasma is generated by means of a discharge can serve as a source of particles that are surface modified, for example coated, in situ in the plasma and can in this manner be prevented from agglomerating. These particles can alternatively be deposited together with coating precursor compounds, thereby forming a coating in which they are incorporated. The present invention accordingly also relates to the use of a discharge in a plasma nozzle, in particular an atmospheric pressure plasma nozzle, for sputtering particles from at least one electrode of the plasma nozzle.

The prior art, such as is represented by DE-B-102 23 865, used electrode materials as components of homogeneous coatings, but not, however, as a source of discrete particles that can be surface modified in situ in the plasma.

Within the meaning according to the invention, an electrode is understood as any component of the used device, in particular a plasma nozzle, that at least intermittently forms the start or finish point of the charge movement.

The invention also relates to a method for producing composite materials, in which surface-modified particles produced using the method according to the invention are incorporated in a matrix, as well as to the so obtained composite materials as such.

According to a further aspect, the invention relates to a specific plasma nozzle that enables the sputtering of particles from electrodes between which the discharge burns, and thus allows the implementation of the method according to the invention for producing surface-modified particles. The plasma nozzle is specified in more detail in independent claim 13. The voltage between the electrode and the counter-electrode, which is preferably a high voltage, is thereby advantageously generated by a voltage generator or high voltage generator. According to a preferred embodiment, the voltage is pulsed. In this case, a pulse generator is used as the voltage generator. Devices comprising such a plasma nozzle as well as a means for feeding chemical compounds into the plasma jet are also proposed. This means is preferably disposed outside of the region of the plasma nozzle in which the plasma is produced.

Preferred configurations of the methods according to the invention for producing surface-modified particles and for producing coatings having particles dispersed therein, as well as of the plasma nozzles and the devices form the subject matter of the dependent claims.

### BRIEF DESCRIPTION OF THE DRAWINGS

Shown in the enclosed figures is the method according to the invention for producing a coating in which the particles are dispersed. The figures only differ as regards the sputter electrodes used to produce the particles. In

FIG. 1, a wire is used as the sputter electrode and in

FIG. 2, an electrode having distinct edges is used. According to the implementation of the method in

FIG. 3, the sputter electrode is a rotating electrode. The figures furthermore allow an illustration of the method according to the invention for producing surface-modified particles.

### DETAILED DESCRIPTION OF THE INVENTION

In the atmospheric pressure plasma method according to the invention, the plasma is produced in a process gas by means of a discharge between electrodes. The plasma is inasmuch produced in a manner such as was common, for example, in atmospheric pressure plasma nozzles of the prior art. Reference is made, for example, to DE-A-195 32 412, DE-U-299 21 694, DE-U-299 11 974 and WO 01/32949. In the prior art such as is represented by the aforementioned documents, a sputtering of electrode material is, however, supposed to be avoided, namely for various reasons. On the one hand, a contamination with electrode material of the substrate surface that is to be cleaned, activated or coated by the plasma jet is supposed to be avoided. A sputtering of electrode material would furthermore reduce the life of the electrode. So as to avoid a sputtering of electrode material, the start and finish point of the discharge by means of which the plasma is produced was thus, in most cases, continually varied in the atmospheric pressure plasmas of the prior art in order to prevent too high a local power input per area in the electrode, as a result of which material could be sputtered. It is stated in DE-B-102 23 865 that electrode material is incorporated in homogeneous coatings. This document does not contemplate the production of discrete particles that can be in situ surface modified or incorporated in coatings. The present invention is, however, based on this idea. It could also not be expected that owing to such an approach, the agglomeration problems associated with microparticles and nanoparticles in the prior art could be avoided and that non-agglomerated, surface-modified, in particular coated, micro- and nanoparticles, especially nanoparticles, or coatings in which such particles are finely dispersed, could be easily obtained.

An “atmospheric pressure plasma”, also referred to as AP plasma or normal pressure plasma, is understood as a plasma in which the pressure corresponds approximately to the atmospheric pressure. C. Tendero et al. provide a review of atmospheric pressure plasmas in “Atmospheric pressure plasmas: A review”; Spectrochimica Acta Part B: Atomic Spectroscopy; 2005. The atmospheric pressure plasmas that can be used in the method according to the invention may be produced by various types of excitation. Coming into question here are AC (alternating current) excitation, DC (direct current) excitation and low-frequency excitation, RF excitation and microwave excitation. According to a particularly preferred embodiment, the atmospheric pressure plasmas are produced by means of a pulsed DC voltage. As was surprisingly found by the inventors, the production of the atmospheric pressure plasma using direct current in the method according to the invention can significantly increase the sputter yield (i.e. the yield of sputtered particles) as compared to AC excitation. Such a pulsed DC voltage can be particularly advantageously produced by interposing a rectifier between the transformer and the electrode. It is particularly advantageous according to the invention for the atmospheric pressure plasma to be a plasma jet that is produced in particular by a plasma nozzle.

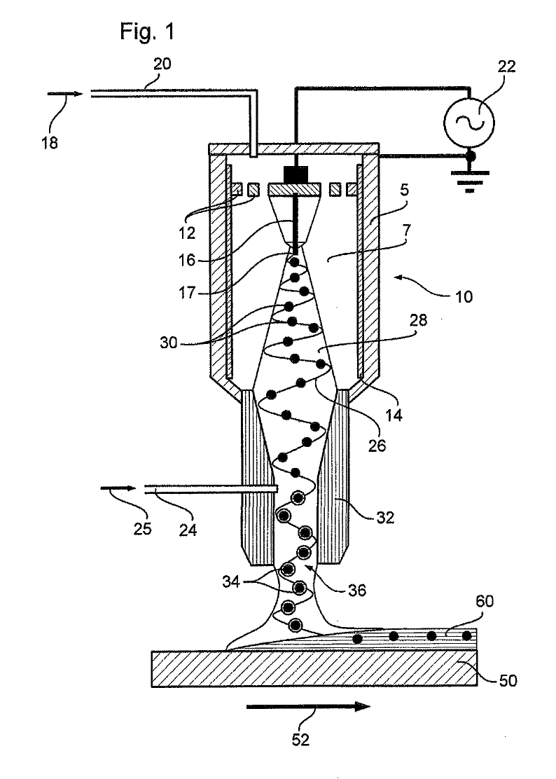

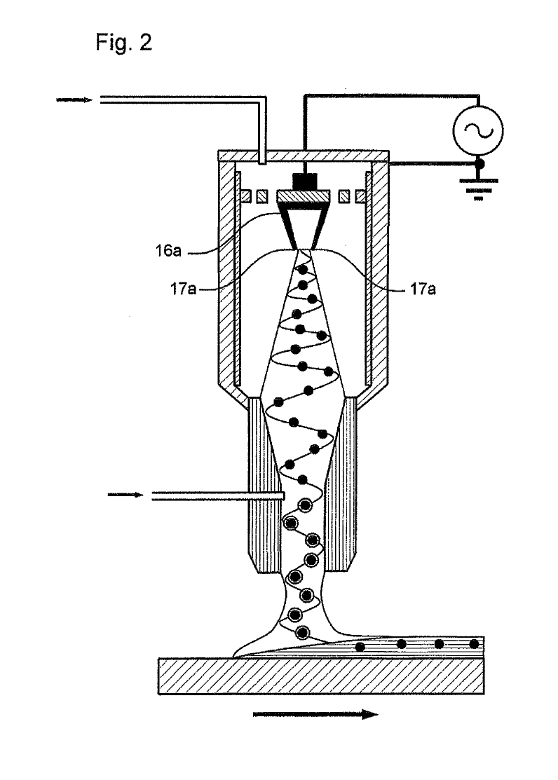

Within the meaning of the present application, the electrode from which particles are sputtered by the plasma-producing discharge in the method according to the invention is referred to as the “sputter electrode”. In the method according to the invention, a plurality of electrodes may be sputter electrodes; however, precisely one of the electrodes is preferably the sputter electrode. If, for example, the method according to the invention is carried out with a correspondingly adapted plasma nozzle or a device comprising such a plasma nozzle, the electrode arranged in the nozzle channel of the plasma nozzle can act as the sputter electrode. This electrode that is arranged in the nozzle channel of the plasma nozzle is labelled with reference number 16 in FIG. 1 and with reference number 16a in FIG. 2. The discharge emanates from this electrode and finishes at the counter-electrode, in the plasma nozzles of FIGS. 1 and 2 at the grounded nozzle head 32.

The methods according to the invention for producing surface-modified particles and coatings having particles dispersed therein proceed in a particularly advantageous manner if the average sputter rate of the at least one sputter electrode is ≧10⁻⁵ cm³/min, more preferred ≧10⁻⁴ cm³/min, even more preferred ≧10⁻³ cm³/min, and most preferred ≧10⁻² cm³/min.

The average sputter rate obviously depends on the used electrode materials.

In order to achieve such high average sputter rates, the discharge can, in the case of stationary sputter electrode(s), be concentrated on a limited area of the sputter electrode(s) that is as small as possible.

This can be achieved in particular in that the sputter electrode(s) has(have) at least one area that is geometrically distinguished. Within the meaning of the present application, a geometrically distinguished area is understood as an area in which the discharge is concentrated owing to the high field strength prevailing there. Typical examples of such geometrically distinguished areas in electrodes are points and edges.

The sputter electrode may, for example, be a wire, from the end of which the discharge emanates. It is particularly advantageous for the end of the wire to be in the form of a point. According to a particularly preferred embodiment, the wire has an average diameter of 0.5 to 5 mm, in particular 1 to 3 mm. Owing to the material removal that results from sputtering, the wire sputter electrode can preferably be advanced. In the present description, “advanceable” in connection with an electrode means that the part of the electrode (in this case the wire) which has been removed as a result of sputtering can be replaced by pushing in the electrode.

The concentration of the discharge on a limited area of the sputter electrode(s) can furthermore be benefitted by the gas flow of the process gas. A directed, swirling flow of the process gas, which can be generated by a swirler, has, for example, proven to be advantageous here.

The sputtering of particles can furthermore be benefitted by the selection of an easily sputterable electrode material. Silver, for example, is such a very easily sputterable material. As was ascertained by the inventors, already useable sputter rates can be achieved with silver electrodes if conventional electrode geometries are used.

On the other hand, too high a power input by the discharge relative to the area of the sputter electrode(s) can lead to the local temperature at the sputter electrode(s) becoming so high that the sputtering of particles which are too large, and in particular a so-called scattering of material, occurs. Thus, in order to sputter small particles such as micro- and nanoparticles, it is advantageous that the power input by the discharge relative to the area of the sputter electrode(s) does not exceed a specific maximum value. An excessive power input and thus the sputtering of particles that are far too large can be prevented as follows in the methods according to the invention.

The first possibility is the pulsed operation of the generator by means of which the discharge, which is preferably an arc discharge, is generated. The pulse frequency of the generator is not specifically restricted and may be 5 to 70 kHz, with the range of 15 to 40 kHz being preferred. Pulse frequencies of 16 to 25 kHz, in particular 17 to 22 kHz, have proven to be particularly advantageous for carrying out the methods according to the invention. In order to increase the amount of sputtered particles (sputter yield), a pulse length of ≧3 ps proved to be suitable. It was furthermore found that the sputter yield as compared to AC excitation can be increased by using a pulsating DC voltage for generating the plasma. Such a pulsed (or pulsating) DC voltage can be generated, for example, by a rectifier located between the pulse generator (transformer) and the nozzle. As could be demonstrated, in particular a high removal of sputtered particles from the negatively-charged electrode is possible when using a pulsating DC voltage. Finally, the sputter yield, i.e. the amount of particles sputtered from the sputter electrode, can be influenced by the pulse-pause ratio of the discharge. In the method according to the invention, the pulse-pause ratio is preferably in the range of 1:0.5 to 1:1000, particularly preferred in the range of 1:1 to 1:20.

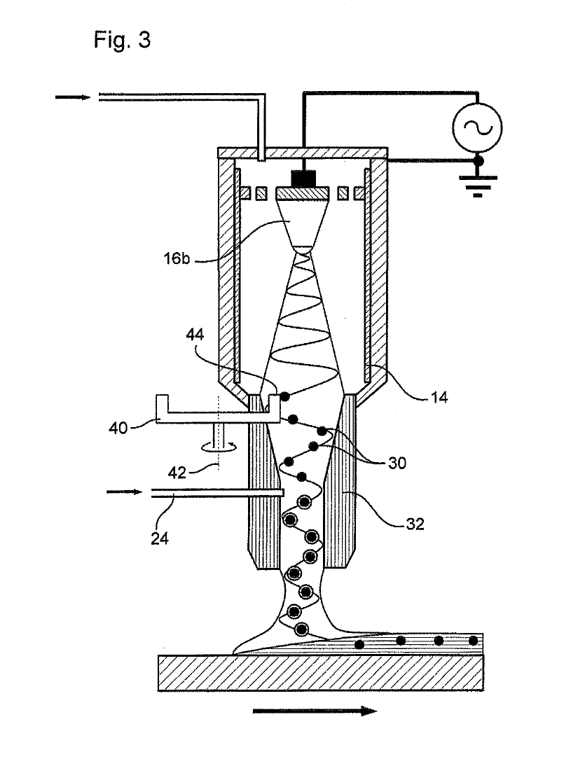

A second possibility is to allow the at least one sputter electrode to rotate or oscillate. By rotating the sputter electrode, it can be achieved that the energy of the discharge does not always impinge upon the same area of the sputter electrode. This can also be achieved by allowing the sputter electrode(s) to oscillate. According to the invention, this is understood to mean that the sputter electrode(s) is(are) periodically moved into and back out of the region of the discharge. In order to nevertheless achieve sufficient sputter rates, the rotating or oscillating electrode preferably has geometrically distinguished areas to which the discharge is drawn owing to the electric field. The discharge therefore impinges upon a spatially restricted area. The rotating counter-electrode can, for example, be designed in the form of a cup drill. This is shown in FIG. 3 (reference number 40).

In particular metals (such as copper and silver) but also metal alloys, metal oxides (for example BaO) and carbon come into question as the material for the sputter electrode(s) and thus also for the sputtered particles. In view of the uses of the surface-modified particles and the coatings containing particles dispersed therein that are produced using the method according to the invention, the following materials are particularly preferred for the sputter electrode(s): silver, zinc, zinc oxide, magnesium, copper, tin, tin oxide, silicon carbide and aluminium bronze. When using a silicon carbide electrode, SiOₓ/glass particles can, for example, be obtained.

As is apparent from that stated above, the sputter conditions in the production methods according to the invention are advantageously selected such that microparticles and/or nanoparticles are sputtered from the sputter electrode. In this description, micro- and nanoparticles are understood as particles having a diameter in the range of nanometres or micrometres. The particles preferably have a diameter in the range of 2 nm to 20 μm. A particularly preferred embodiment relates to nanoparticles, i.e. to particles having a diameter in the nanometre range, in particular in the range of 2 to 100 nm. Furthermore, the average (volume-average) particle diameter of the sputtered particles is preferably also in the range of nano- or micrometres, more preferred in the range of 2 nm to 20 μm, particularly preferred in the range of 2 to 100 nm. The determination of the grain size of very small particles, such as nanoparticles, is possible, for example, by means of laser scattering methods or transmission electron microscopy (TEM). For larger particles, sieve analysis and centrifugation methods are also available. In contrast, in the case of the scattering of material of the electrodes that is preferably to be avoided within the meaning of the invention, particle diameters of >100 μm with an average particle diameter of >50 μm occur.

In the method according to the invention, the distance between the electrodes, between which the discharge is generated, is not specifically restricted. The distance can be, for example, between 5 and 100 mm. In respect of the amount of sputtered particles (sputter yield), an electrode distance of preferably between 8 and 50 mm did, however, prove to be particularly advantageous.

In the first aspect of the method according to the invention, particles having a modified surface are produced. In the present application, “modification” is understood in two different ways. Firstly, it means the functionalisation of the surface of the particles. Occurring during functionalisation of the particle surface is, for example, an exchange of groups at the surface or the introduction and/or incorporation of functional groups or also of atoms. Secondly, “modification” means the coating of the particle surface, i.e. in particular the application of an adhering layer, for example a polymer layer.

Modification of the surface of the particles in the plasma can take place by feeding a chemical compound into the plasma. In the case of the functionalisation of the particles, the chemical compound may be one which, in the plasma, introduces functional groups and/or atoms into the surface of the sputtered particles. Hydrogen, oxygen and nitrogen-hydrogen compounds, in particular amines, can, for example, be cited in this regard. Such chemical compounds may, for example, be transported into the plasma jet by way of a feeding means which, in the case of a plasma nozzle, can be arranged, for instance, below the nozzle outlet.

Modification of the surface of the particles in the plasma can also take place by means of the process gas of the plasma itself. In this case, the process gas contains a chemical compound by means of which the surface of the particles is modified in the plasma. Using nitrogen as the process gas makes the particle surfaces nitridic and using oxygen makes them oxidic. Oxide-free particle surfaces can be obtained, for example, by using noble gasses, in particular with the addition of hydrogen which reduces possible traces of oxygen in the atmosphere.

The person skilled in the art is familiar with useable process gasses that can be used, for example, in plasma nozzles. It is possible, for example, to use nitrogen, oxygen, hydrogen, noble gasses (in particular argon), ammonia (NH₃), hydrogen sulphide (H₂S) and mixtures thereof, in particular compressed air, nitrogen-hydrogen blends and noble gas-hydrogen blends. As became apparent, the use of oxygen as the process gas leads to the production of more particles (increase in the sputter yield) as compared to nitrogen as the process gas. Oxygen is therefore preferred as the process gas.

The flow rate of the process gas through the atmospheric pressure plasma is not specifically restricted and can be, for example, in the range of 300 to 10000 l/h. Since it was found that lower flow rates of the process gas tend to increase the sputter yield, the flow rate according to the invention is preferably in the range of 500 to 4000 l/h.

In the method according to the invention, the sputtered particles are preferably transported by the process gas.

Modification of the surface of the sputtered particles can basically take place in the region of the active or relaxing plasma. “Active” plasma is generally understood as a plasma that is located within the volume delimited by the electrodes between which a voltage is applied, by means of which the plasma is generated. The region of the relaxing plasma is, on the other hand, located outside of the excitation zone that is delimited by the cited electrodes. The region of the relaxing plasma is occasionally also referred to as the “after glow” region.

When modifying the sputtered particles by introducing chemical compounds into the active region of the plasma, there is the danger that the surface of the electrodes will be modified, for example coated, if coating precursor compounds are used as the chemical compounds. A pre-reaction, for example pre-polymerisation of coating precursor compounds, is also more likely in the region of the active plasma. For these reasons, it is preferred for the surface modification of the sputtered particles to take place in the region of the relaxing plasma.

In the method according to the invention for producing surface-modified particles, a sufficient dwell time of the sputtered particles in the plasma in contact with the chemical compounds is advantageous in order to increase the degree of surface modification. Typical dwell times are 10⁻⁵ to 10⁻¹ s. This dwell time can be influenced, for instance if a plasma nozzle is used, by the flow velocity of the process gas and the length of the path between the site of introduction of the chemical compounds for surface modification and the site of collection of the particles, for example in an inert medium.

In the case that the sputtered particles are supposed to be coated in the plasma, they can be brought into contact with a coating precursor compound.

The coating precursor compound may be a compound which, in atmospheric pressure plasma, can form coatings, in particular polymer coatings, very particularly plasma polymer coatings, around the particles. Examples of coating precursor compounds that can lead to hydrophobic coatings are hexamethyl-disiloxane (HMDSO), tetraethoxysilane (TEOS), hexamethyl-disilazane (HMDS), acetylene, maleic acid, oleic acid, linoleic acid and linolenic acid. Depending on the plasma conditions and the process gas used—for example if oxygen-containing process gasses, in particular oxygen, are used—, the cited coating precursor compounds can also lead to coatings that are rather hydrophilic. For coatings that are more hydrophilic, acrylic acid, methacrylic acid and methacrylic acid methyl ester have proven to be suitable. Pyrrole and pyridine are suitable for coatings with nitrogen-containing groups. Further examples of coating precursor compounds that can be used for polymer coatings are N-trimethyl chitosan, benzoquinone and polyvinylpyrrolidone. Finally, toluene, cyclohexane, fluorine-containing compounds (for instance decafluoropentane), thiophene as well as very generally organometallic compounds come into question as coating precursor compounds.

According to a particularly preferred embodiment, the surface of the sputtered particles is provided in the plasma, preferably the relaxing plasma, with a plasma polymer layer that covers at least part of the surface of the sputtered particles. In a plasma polymerisation process, the precursor compounds, in this case coating precursor compounds, are first of all fragmented/ionised/excited and then polymerised. This is the difference as compared to polymerisation in the conventional sense. The plasma polymer is the product of the plasma polymerisation of the coating precursor compounds.

The surface-modified particles obtained with the method according to the invention can then be suitably collected. Coming into question as the collection media are polymers and oligomers in general, such as polyols, vinyl esters, epoxide resins, urethanes, acrylates, and furthermore, preferably low-molecular, liquids such as water, alcohols, ketones, aliphatic and aromatic solvents. According to a preferred embodiment, a reaction does not occur between the surface-modified particles and the collection medium. The collection media, in particular liquids, which have the surface-modified particles dispersed therein, can be directly introduced into, for example, lacquers, adhesives and plastics. The surface-modified particles dispersed in a suitable collection medium can therefore be used as a masterbatch. An example is the collection of surface-modified particles obtained using the method according to the invention in a polyol, which, as a masterbatch, is added to a polyisocyanate-containing mixture as a second component to thus obtain a polyurethane having surface-modified particles dispersed therein. In order to prevent the agglomeration of the dispersed surface-modified particles, dispersing agents, for example surfactants, can be added to the collection medium, in particular the liquids. If the surface-modified particles are only supposed to be stored, silicone oil also comes into question as the collection medium.

It goes without saying that in the method according to the invention for producing surface-modified particles, in which particles sputtered from electrodes are modified in situ, some of the particles may possibly remain unmodified. A separation of the modified particles from the unmodified particles can be achieved using conventional methods. For example, centrifugation, electrostatic separation or chemical precipitation reactions come into question for this purpose. According to a preferred embodiment, separation of the mixture of modified and unmodified particles, in particular of coated and uncoated particles, occurs based on the different sedimentation rates in a sedimentation liquid. The mixture of modified and unmodified particles is accordingly conveyed in the sedimentation liquid. For example, in the case that the method for producing surface-modified particles takes place in a plasma nozzle (as explained below), the gas flow containing modified and unmodified particles is collected in the sedimentation liquid. The sedimentation liquid that may be used is not specifically restricted as long as the modified and unmodified particles which are to be separated have a significantly different sedimentation rate therein so that a separation such as described above is possible. The person skilled in the art will suitably select the sedimentation liquid for a system of modified and unmodified particles that is to be separated by observing whether a separation of particles occurs in the selected test liquid and then analytically examining the settled fraction and the other fraction of the particles, for example by means of XPS. Specific examples of useable sedimentation liquids are water, oils (for example silicone oils), alcohol (in particular lower alcohols such as methanol, ethanol and propanol, very particularly ethanol) and ammoniacal solutions.

The surface-modified particles, in particular the surface-functionalised particles, produced with the method according to the invention may then be subjected to a further reaction in a liquid medium, i.e. to a post-functionalisation. Typical reactants here are epoxy compounds, vinyl esters, isocyanates, polyols, amines, carboxylic acids as well as polymers and polymer precursors. This reaction can also take place directly in the sedimentation liquid. This is a particularly preferred embodiment.

Surface-modified particles produced with the method according to the invention can be incorporated in a wide variety of materials. Cited as examples are adhesives, plastics, lacquers, pharmaceutical preparations and paints as well as individual components or precursors of these materials.

In the method for producing a coating having particles dispersed therein and the method for coating a substrate as according to the second aspect of the invention, which is explained in more detail in the enclosed figures, it is not necessary but is also not ruled out that the sputtered particles are already coated as they move through the plasma. When the (optionally at least partially coated) sputtered particles and the coating precursor compounds that are fragmented, ionised and/or excited in the plasma impinge upon the substrate, the coating having particles dispersed therein is then formed. In the coatings having particles dispersed therein that are produced according to the invention, the coating (for example the plasma polymer) and the dispersed particles are present as separate phases.

In the method for producing a coating having particles dispersed therein as according to the present invention, the relative velocity between the plasma nozzle, by means of which the atmospheric pressure plasma can advantageously be produced, and the substance may be in the range of mm/s to m/s and may, for example, be up to 200 m/min. The coating amount per area can be adjusted by means of the cited relative velocity. In the method according to the invention for producing coatings, the distance between the nozzle and the substrate, which also influences the coating amount per area, may furthermore be 1 mm to several cm, for example a maximum of 10 cm.

There are numerous applications for the coatings having particles dispersed therein that are produced using the method according to the invention. For example, a plasma polymer layer having silver nanoparticles dispersed therein can be used as a non-cytotoxic, antimicrobial coating, for example in the field of medicine, for household appliances and in hygiene articles. A coating for the active corrosion protection of metals that are each more precious than zinc or magnesium, can be obtained with a coating produced according to the invention, which comprises zinc or magnesium particles dispersed therein. A plasma polymer layer containing UV-absorbent particles, such as ZnO, can be used as a UV-absorbent scratch protection coating. Furthermore, conductive, transparent layers can be produced with the method according to the invention. Catalyst applications and the use of the coatings as optical coatings, in particular high-index coatings, are also conceivable.

In the method according to the invention, the agglomeration of the sputtered particles, in particular micro- and nano-particles, can be suppressed in a particularly effective manner if the dwell time of the sputtered particles in the plasma before they are surface modified is as short as possible.

The plasma nozzles according to the invention, such as are specified in independent patent claim 13, can be produced by restructuring conventional plasma nozzles, in particular atmospheric pressure plasma nozzles, such as are described, for example, in DE-A-195 32 412, DE-U-299 21 694 and DE-U-299 11 974. In such plasma nozzles, at least one electrode can act as the sputter electrode. Specifically, this may be, for example, the advanceable wire electrode or the rotatable or oscillatable counter-electrode. According to a preferred embodiment, the rotatable, oscillatable or advanceable counter-electrode is the sputter electrode in the plasma nozzle according to the invention. It is particularly advantageous for the rotatable, oscillatable or advanceable counter-electrode, which acts as the sputter electrode, to be grounded whilst a high voltage is applied to the electrode. This avoids the problems of maintaining electrical contact between the moveable electrode and the high voltage supply. These plasma nozzles are suitable as such for implementing the method according to the invention for producing surface-modified particles when a process gas is used that can modify, in particular functionalise, the surface of the particles in the plasma.

These plasma nozzles may additionally be provided with means for feeding chemical compounds, in particular coating precursor compounds, into the plasma jet. These means may be, for example, an attachment to the nozzle outlet of the atmospheric pressure plasma nozzle, which comprises a line through which the chemical compounds can be fed into the plasma. The atmospheric pressure plasma methods according to the invention can be carried out in a particularly advantageous manner with devices that comprise a plasma nozzle according to the invention and such means for feeding in chemical compounds.

Embodiment examples of the invention will be explained in more detail below by means of the drawings. The examples illustrated herein are provided to facilitate understanding of the invention but not to limit the scope of protection as defined in the dependent claims. FIG. 1 shows a schematic cross-sectional view of a first embodiment of a plasma nozzle according to the invention, FIG. 2 shows a schematic cross-sectional view of a second embodiment of a plasma nozzle according to the invention, and FIG. 3 shows a schematic cross-sectional view of a third embodiment of a plasma nozzle according to the invention.

FIG. 1 provides a schematic representation of the method according to the invention for producing a coating having particles dispersed therein using an atmospheric pressure plasma that is produced by means of a plasma nozzle 10. The plasma nozzle comprises an electrically conductive housing 5, which is preferably configured in an elongated, in particular tubular, manner, as well as an electrically conductive nozzle head 32. The housing 5 and the nozzle head 32 form a nozzle channel 7 through which a process gas flows. The sputter electrode 16 is arranged in the nozzle channel. In FIG. 1, an advanceable wire is provided as the electrode. A tube 14 made of an insulating material, for example a ceramic tube, is inserted in the nozzle channel. A voltage is applied between the electrode 16 and the housing 5/nozzle head 32 by means of a pulse generator 22. The pulse frequencies of the generator 22 are not specifically restricted and are preferably in the ranges as specified in the general part of the description. A rectifier (not shown in the figures) may advantageously be connected between the pulse generator 22 and the electrode 16. The housing 5 and the nozzle head 32 are grounded in the shown example. The process gas 18 is introduced into the nozzle channel 7 via a line 20, namely in such a manner in the shown example that it flows through the channel in a swirling manner. The swirling or spiralling flow of the process gas is illustrated by the spiral line 26. Such a flow of the process gas can be achieved by means of a swirler 12. This swirler may be a plate with holes. Furthermore, a modification of the sputtered particles can be achieved by means of a suitable choice of process gas. This has already been explained above in the general part of the description. Owing to the high voltage, a discharge, in particular an arc discharge, is ignited from the wire electrode 16 to the part of the housing which is not covered with the insulating layer 14, in this case the nozzle head 32. Owing to the discharge, particles 30, preferably micro- and nanoparticles, are sputtered from the tip 17 of the electrode 16 and are transported with the swirling gas flow 28. Coating precursor compounds 25 are supplied via the line 24. Depending on the type of coating precursor compound, it may be fed into the atmospheric pressure plasma via the line 24 in a gaseous, liquid or solid, powdered state, with the gaseous state being preferred. The transport of the coating precursor compound through the line 24 optionally occurs with the aid of a carrier gas, such as air or nitrogen. HMDSO, TEOS and HMDS may, for example, be supplied as gas which is generated, for instance, by means of a vaporiser (not shown).

Owing to contact with the coating precursor compounds 25, at least some of the particles 30 are coated and form coated particles 34. These can be directly collected as such, for example in a suitable medium such as silicone oil. This is not shown in FIG. 1.

FIG. 1 rather shows a method for producing a coating having particles dispersed therein. In the nozzle channel downstream of the point of entry of the line 24 for feeding in the coating precursor compounds, all of the particles 34 are shown as completely coated particles, i.e. as particles having a core and a coating shell. However, in reality, only some of the particles 30 may be coated with the coating precursor compounds 25 to form a shell. It is decisive that when the plasma jet having the particles contained therein impinges upon the substrate 50, a coating 60 is formed from the coating precursor compounds and the particles, which consists of a matrix formed from the coating precursor compounds and having particles 30 dispersed therein. As is shown by the arrow 52, the substrate 50 is hereby moved relative to the plasma nozzle 10.

In FIG. 1, the coating precursor compounds are fed via the line 24 into the region of the active plasma which is delimited by the electrode 16 and the nozzle head 32 that acts as the counter-electrode. Alternatively, feeding in via the line 24 can take place at a point between the nozzle outlet 36 and the surface of the substrate 50 in the region of the relaxing plasma. This embodiment is preferred since a coating of the counter-electrode, in this case the nozzle head 32, can thus be avoided.

FIG. 2 corresponds to FIG. 1 except for the fact that the sputter electrode, labelled therein as 16a, has a specific geometric shape. It is specifically an inverted frustum, at the edges 17a of which the sputtering of the particles 30 occurs.

FIG. 3 also corresponds to FIG. 1, with a few differences. In FIG. 3, the counter-electrode is the sputter electrode. Used in this case as the electrode 16b, from which the discharge emanates, is an electrode such as is conventionally used in plasma nozzles. The sputtering of particles is negligible at this electrode; sputtering occurs predominantly at the counter-electrode 40, which can be rotated about an axis 42. Particles 30 are sputtered at the edge 44 of the electrode 40 owing to the discharge between the electrode 16b and the counter-electrode 40, these particles being transported with the carrier gas flow and being brought into contact with coating precursor compounds that are fed in via the line 24. In FIG. 3, the discharge burns predominantly between the electrode 16b and the rotating counter-electrode 40 that is grounded. This preference results from the fact that the edge 44 is geometrically distinguished and the electrical field strength is particularly high there.

Nevertheless, the discharge in the shown representation can additionally run, at least intermittently, between the electrode 16b and the also grounded nozzle head 32. In order to further promote the formation of a discharge between the electrodes 16b and 40, and thus the sputtering of particles from the rotating counter-electrode, the potential difference between the electrodes 16b and 40 as compared to the potential difference between the electrode 16b and the nozzle head 32 can be further increased. A further possibility is to guide the insulation 14, which is made, for example, of ceramic, over the entire interior of the housing, including the inner surface of the nozzle head 32, and to only leave the rotating counter-electrode uninsulated. In this case, the discharge can only run between the electrode 16b and the rotating sputter electrode 40, which increases the sputter rates at the rotating counter-electrode.

Instead of the rotating sputter electrode 40, one or more grounded, advanceable sputter electrodes 40, for example wires, such as were specified in more detail in the general part of the description, may also be provided. Coming into consideration here are, for example, radially converging wires, for example 6 thereof, in the region of the rotating sputter electrode 40. This is not shown in FIG. 3.

1. A method for producing surface-modified particles in an atmospheric pressure plasma comprising producing said plasma in a process gas by means of a discharge between electrodes,
characterised in that at least one of the electrodes is a sputter electrode; sputtering particles from the sputter electrode into the plasma by the discharge, and subsequently modifying the surface of the particles in the plasma.

2. The method according to claim 1, characterised in that the surface modification of the sputtered particles occurs in the region of the relaxing plasma.

3. The method according to claim 1, characterised in that the surface of the particles is modified by bringing the particles into contact with a chemical compound.

4. The method according to claim 1, characterised in that the particles are coated in the plasma.

5. A method for producing a coating having particles dispersed therein using an atmospheric pressure plasma, comprising producing said plasma in a process gas by means of a discharge between electrodes, characterised in that at least one of the electrodes is a sputter electrode; sputtering particles from the sputter electrode into the plasma by the discharge; depositing said particles, together with coating precursor compounds on a substrate, and forming a coating having the particles dispersed therein.

6. The method according to claim 5, characterised in that the coating is a plasma polymer coating.

7. The method according to claim 1, characterised in that the discharge is driven by a pulsed, DC voltage.

8. The method according to claim 1, characterised in that the average sputter rate when sputtering the sputter electrode is ≧10⁻⁵ cm³/min.

9. The method according to claim 1, characterised in that during sputtering, the sputter electrode rotates or oscillates.

10. The method according to claim 1, characterised in that the sputtered particles have a particle size in the nanometre to micrometre range.

11. A method for producing a composite material, comprising incorporating surface-modified particles into a matrix using the method of claim 1.

12. (canceled)

13. A plasma nozzle comprising
a housing that forms a nozzle channel through which a process gas can flow,
an electrode arranged in the nozzle channel, and
a counter-electrode arranged in the nozzle channel, wherein
a voltage is applied between the electrode and the counter-electrode to form a plasma jet that exits from the outlet of the housing,
characterised in that the counter-electrode is rotatable, oscillatable or advanceable.

14. The plasma nozzle according to claim 13, wherein the counter-electrode is grounded.

15. A device comprising the plasma nozzle of claim 13 and a device for feeding chemical compounds into the plasma jet.

16. (canceled)

17. The method according to claim 5, characterised in that the discharge is driven by a pulsed, DC voltage.

18. The method according to claim 5, characterised in that the average sputter rate when sputtering the sputter electrode is ≧10⁻⁵ cm³/min.

19. The method according to claim 5, characterised in that during sputtering, the sputter electrode rotates or oscillates.

20. The method according to claim 5, characterised in that the sputtered particles have a particle size in the nanometre to micrometre range.

21. The method according to claim 1, characterised in that the average sputter rate when sputtering of the sputter electrode is ≧10⁻⁴ cm³/min.

22. The method according to claim 5, characterised in that the average sputter rate when sputtering of the sputter electrode is ≧10⁻⁴ cm³/min.
